(19) United States
(12) Patent Application Publication
(10) Pub. No.: US 2017/0099825 A1
(43) Pub. Date: Apr. 13, 2017

(54) Equine Boot Assembly Having An Adjustable Heel Lift

(71) Applicant: Monty L. Ruetenik, Clear Lake City, TX (US)

(72) Inventor: Monty L. Ruetenik, Clear Lake City, TX (US)

(21) Appl. No.: 15/082,749

(22) Filed: Mar. 28, 2016

Related U.S. Application Data
(60) Provisional application No. 62/239,864, filed on Oct. 10, 2015.

(51) Int. Cl. A01L 7/02; A01K 13/00; A61B 6/00; A01K 29/00

(52) U.S. Cl. CPC A01L 7/02; A01K 29/005; A01K 13/007; A61B 6/508

(57) ABSTRACT

An equine boot assembly and system providing a heel lifting adjustable wedge (inflatable bladder or other suitable means) to lift the heel section of an equine hoof and optionally providing a shock absorbing cushioning pad and frog support. Lifting the heel has many benefits including relieving and reducing the consequences of laminitis by reducing the tension on the deep digital flexor tendon to allow the equine to find a more natural comfortable balance on damaged hooves. There is additionally disclosed a rocker attachment to the boot system to provide added rocker movement (better break-over) that has been shown to be beneficial in many cases.

### CROSS-REFERENCE TO RELATED APPLICATION

This application claims the benefit and priority from U.S. Provisional Patent Application 62/239,864 filed Oct. 10, 2015, the contents and disclosure of which is incorporated herein by reference for all purposes.

### BACKGROUND

Field of the Invention

This invention relates to equine boots and specifically to a boot assembly and method for providing an adjustably heel lift to an equine hoof.

Background

Laminitis is a costly disease for equine owners. Many better known and famous racehorses have had to be put down because of laminitis and there is a continuing search for a causes and cures. “Laminitis” or “founder” is an equine hoof disease where the coffin bone (third phalanx, P3) begins to lose its attachment to the inner hoof wall and begins to rotate toward the front of the hoof or sink within the hoof capsule. For example, an injury or upset to some part of the body is combated by the circulatory system as blood rushes to the injured area. The momentary reduction in blood flow deprives the capillaries which feed the lamina. The lamina is the “velcro” that attaches the bone to the hoof wall. In the brief time the lamina lacks sufficient blood flow, the capillaries begin to die and the “Velcro” attachment is weakened. Chronic laminitis commonly involves the distal displacement (rearward movement/rotation and sometimes sinking) primarily due to trauma, insult or swelling of the lamina (attachment tissue) of the P3 (coffin bone or distal phalanx) to the hoof wall. The deep flexor tendon is attached to the bottom (palmar surface) of the coffin bone. This tendon is an extension of a muscle which reacts to the pain of the tearing lamina. As the muscle contracts, the tendon is in tension and pulls on the coffin bone. The deep digital flexor tendon, (doing its job), continues to keep tension on the boney column and further pulls the P3 out of the ideal position within the hoof capsule, resulting in an alignment shift of the weight-bearing functionality of the P3 from its solar surface (bottom of bone should be parallel to the ground surface). This realignment, results in chronic pain and over time decreased sole growth (contracted heels etc.). Many realignment techniques of the P3 cannot be achieved during the initial developmental stages of laminitis because the hoof capsule is unstable and continually changing. Many traditional mechanical realignment procedures like therapeutic

While lameness, especially that caused by laminitis is difficult to cure, it is possible to relieve some of the pressure and pain by use of proper trimming, shoes or boots that allow the horse to find a comfortable position and to relieve unnecessary pressure on a lame hoof. Such relief is often essential to an eventual cure.

It is well established that early treatment of laminitis is critical. Researchers and practitioners agree that frog support is needed and that relief of the tension on the coffin bone by the deep digital flexor is essential—thus lifting the heel of the hoof to increase the angle of the diseased hoof is important. The Horse: Your guide to Equine Health Care, 2009 Blood Horse Publications. Regarding hoof treatment of laminitic equine, it has been said “Many farriers feel that supporting the frog is of immediate concern as soon as symptoms are noticed. Support can be given by padding up around the frog with gauze bandages or a commercially available “lily pad”™ which can be fitted whilst a horse is still wearing shoes. Immediate pain relief can be offered by using a wedge to raise the heel, thus relieving pressure from the toe area. Raising the heel reduces the pull on the rear of the pedal bone and may help to minimize further lamellar tearing.” See The Cyberhorse Guide to Horse Health; www.cyberhorse.net.au/cgi-bin/tve/displaynewsitem.pl?20040325laminitispt3.txt.

It is also considered important to provide means to allow the laminitic equine to be able to reduce hoof pressure from sharp break-over of the hoof when walking and to allow it to find its own most comfortable standing position. This can be accomplished by so called “rocker” shoes. One commercial shoe that has found acceptance is sometime called a “banana” or “rocker” shoe or clog. This is a shoe that is shaped to allow break-over adjustment by a “rocker” effect of the sole of the hoof so that the horse can more easily find a comfortable position—by adjusting the palmar/planar angle to take pressure and stress off affected areas of the hoof. The “Clog” is a shoe developed by Dr. Micheal L. Steward, DVM of Oklahoma is one of the first to use the concept of a self-adjusting in a wooden shoe that is screwed and/or glued directly to the hoof. Adaptations of the Stewart Clog have been made of other than wooden materials. These shoes, while somewhat effective are attached directly to the hoof and are not, therefore, easily changed or adjusted without damage to the hoof.

The present invention is a boot assembly with heel lift means and optional frog support that is efficient, easily applied without the assistance of an expert farrier and can easily be utilized directly by an equine owner or its veterinarian.

### SUMMARY OF THE INVENTION

Disclosed is an equine boot assembly and system providing a heel lifting adjustable wedge (inflatable bladder or other suitable means) to lift the heel section of an equine hoof and optionally providing a shock absorbing cushioning pad and frog support. Lifting the heel has many benefits including relieving and reducing the consequences of laminitis by reducing the tension on the deep digital flexor tendon to allow the equine to find a more natural comfortable balance on damaged hooves. In one embodiment there is additionally provided a rocker attachment to the boot system to provide added rocker movement (better break-over) that has been shown to be beneficial in many cases.

### DESCRIPTION OF THE DRAWINGS

FIG. 1 is a side view of a boot assembly with the heel lift component in a deflated position that is an embodiment of the present invention.

FIG. 2 is a side view of a boot assembly with the heel lift component in a partially inflated deflated position that is an embodiment of the present invention.

FIG. 3 is a side view of a boot assembly with the heel lift component in an inflated deflated position that is an embodiment of the present invention.

FIG. 4 is a perspective view of an orthotic pad of an embodiment of the invention showing placement of heel lift bladders.

FIG. 5 is a perspective view of an inflatable bladder of an embodiment of the invention.

FIG. 6 is a top view of an orthotic pad of an embodiment of the invention showing the inflator pad, front stop and frog support.

FIG. 7 is a perspective view of an orthotic pad of an embodiment of the invention showing a recess section in the bottom surface for a bladder fitting.

FIG. 8 is a perspective view of an orthotic pad of an embodiment of the invention showing a recess in the bottom surface for a bladder fitting and recess for a bladder.

FIG. 9 is of a boot assembly of an embodiment of the invention showing a bladder inflator tube leading out inside the boot.

FIG. 10 is of a boot assembly of an embodiment of the invention showing a bladder inflator tube leading out outside the boot.

FIG. 11 is a side view of a boot sole rocker attachment that allows the boot/attachment showing optional screws and barrel nuts as means to secure the attachment to the boot sole.

FIG. 12 is a side view of a boot sole rocker attachment of FIG. 11 showing the boot assembly tilted forward.

### DETAILED DESCRIPTION OF THE INVENTION

In broad scope the invention is an equine boot system and assembly providing a heel lifting adjustable wedge (inflatable bladder or other suitable means) to lift the heel section of an equine hoof and optionally to provide hoof frog support. Lifting the heel is useful in reducing the tension on the deep digital flexor tendon (DDFT) and to relieve the consequences of laminitis and other damage of the hoof. In one embodiment there is additionally provided a rocker attachment to the boot system to provide enhanced break-over. This additional rocker ability has been shown to be beneficial in many cases.

The boot heel lift and rocker attachments of this invention provides an efficient, readily adjustable approach to sole supportive realignment of the P3 and hoof structure and allows the equine to self-adjust its stance to find the most comfortable position. It allows the equine to relieve the tension placed on the deep digital flexor tendon by the displacement of the hoof structure in laminitis. A significant advantage of the adjustable heel lift system of the present invention is that it does not require special training or a specialized farrier. Other currently available heel lift systems have to be specially fitted and attached directly to the hoof. If improperly fitted such heel lift attachment can cause more harm than good. Badly fitted shoes can permanently cripple a horse. The present invention is easily used by any horse owner or veterinary practitioner and can be used even in remote areas that do not have the advantage of a local equine podiatrist available and thus provides a more economical and more readily available solutions to equine lameness.

The heel lifting means (wedge) is illustrated herein as an expandable bladder (bag), however, it may be a mechanical device as well. For example, it may be two plates hinged at one end with a lifting piston at the other end disposed between the plates. The piston(s) may be pneumatic or mechanical such as a screw much like the screw structure of an accordion automobile jack. There may be a single piston with or without a bar that substantially spans the width of the top plate(s) or multiple pistons (two will normally suffice). The lifting power need not be especially great, therefore hand or battery operated pistons will generally be sufficient.

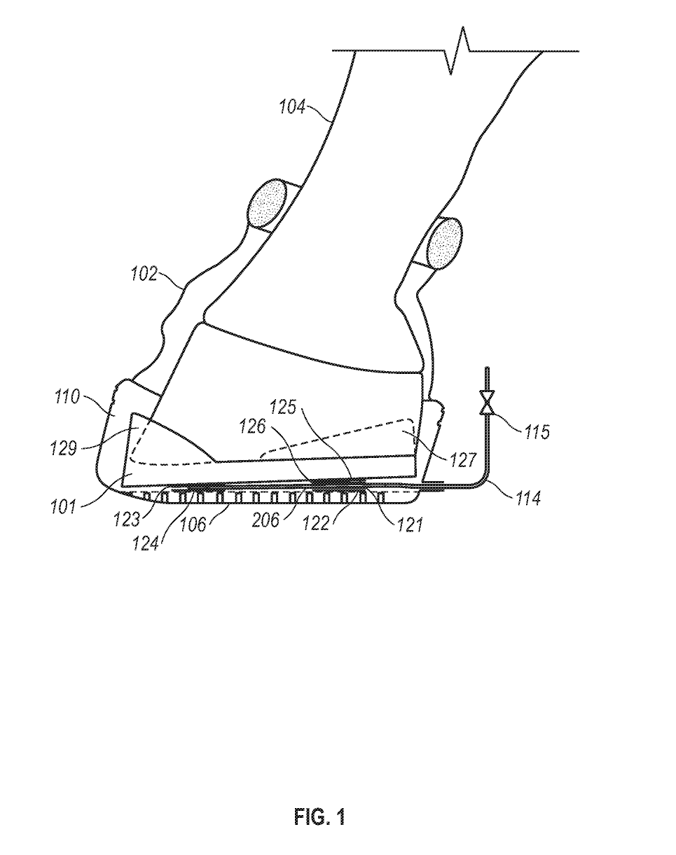

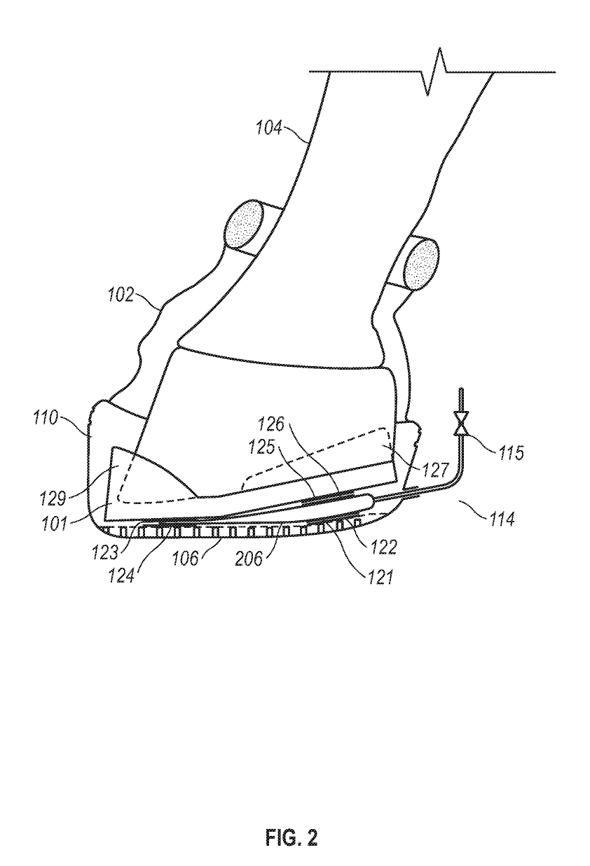

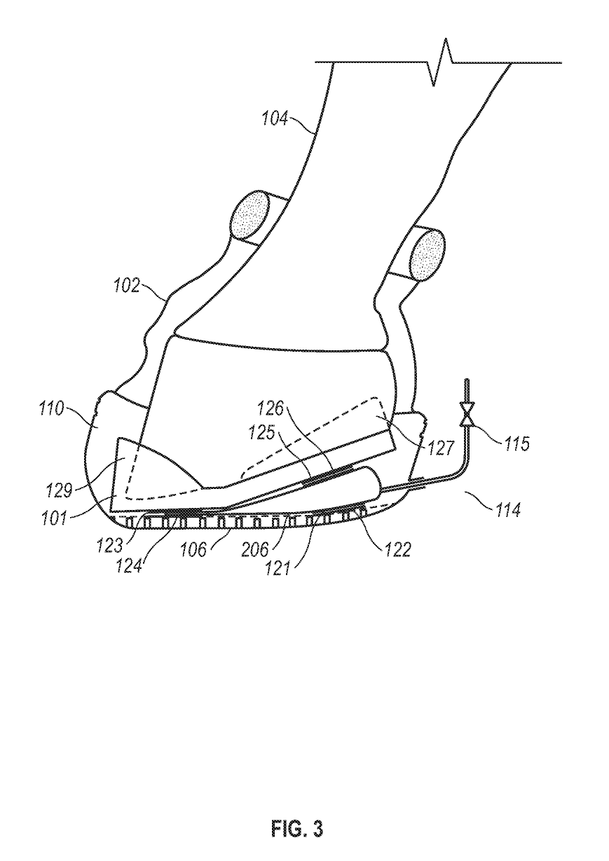

Referring to the Figures, FIG. 1-3 illustrate a boot assembly 102 with the heel lift wedge (inflatable bladder) 206 disposed under the rear or heel section of an orthotic elastomer pad 101. The orthotic pad is disposed in the bottom of an equine boot and placed so as to be beneath an equine hoof (attached to leg 104) when in use. FIG. 1 shows the heel lift wedge (inflatable bladder) in the un-lifted original position. Note that the boot sole 106 is sloped at the front but only rounded at the rear. FIG. 2 shows the lift partially inflated so that the pad 101 is bent in the center and the rear of the pad lifted (and thus the heel of the hoof lifted). Note that the rear of the boot sole 106 is even more sloped—this from the downward force of the hoof and the lift. This is beneficial as it provides more rocker action to the boot sole. In FIG. 3 the heel lift is more fully inflated, and the sole 106 more sloped. This rounding of the sole when the bladder is inflated enables the equine to have a stable flat resting position and the boot sole deflects outward as the horse starts to unweight which is when break over becomes important. This rounding ability of the assembly provides a dynamic full roller motion system.

The sole piece of the boot must be sufficiently rigid to provide protection for the boot but sufficiently flexible to allow it to bend as described above. Moreover, the boot must be able to be tightly attached to the boot so as to force the sole to bend rather than stretch or expand the boot structure itself. An interesting aspect of this ability of the sole to flex and become more rounded when the bladder is inflated is that it also provides a variable rocker effect that aids in assisting the animal in obtaining relief. When the equine's weight is on the boot the sole is less rounded, and when it lifts its hoof (reducing the weight on the boot) the sole becomes more rounded. This is true at whatever inflation level of the bladder. Thus, when the hoof is lifted (and downward pressure on the boot reduced) the sole become more sloped on the back and front (more rounded) and provides even greater initial break-over flexibility when weight is again applied. The construction of boot sole is discussed more fully below. In a prototype boot assembly the lift from the original position to the inflated position was about one to 1½/inches.

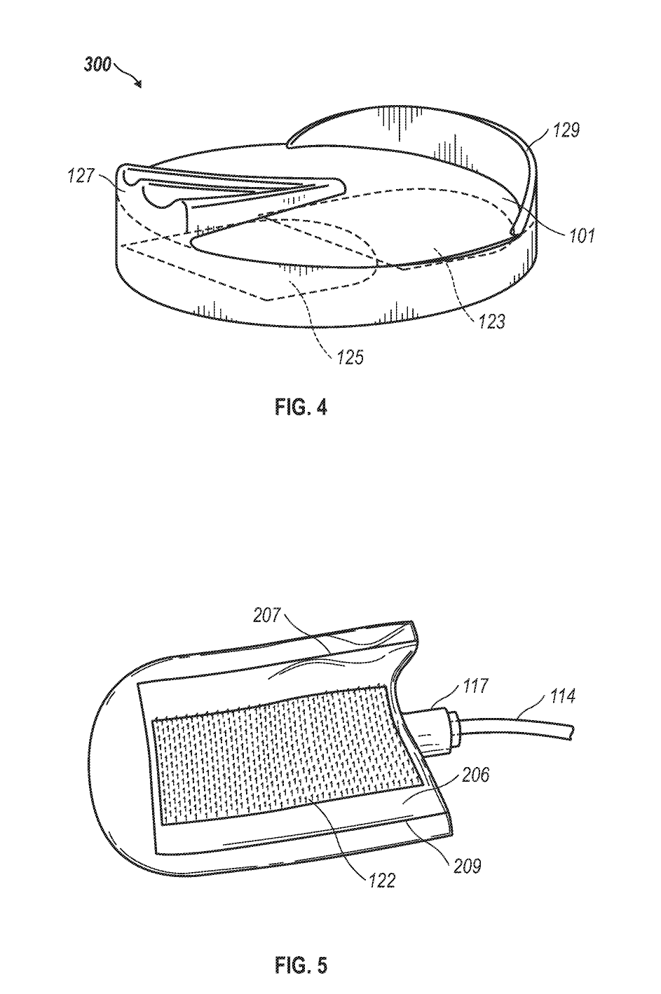

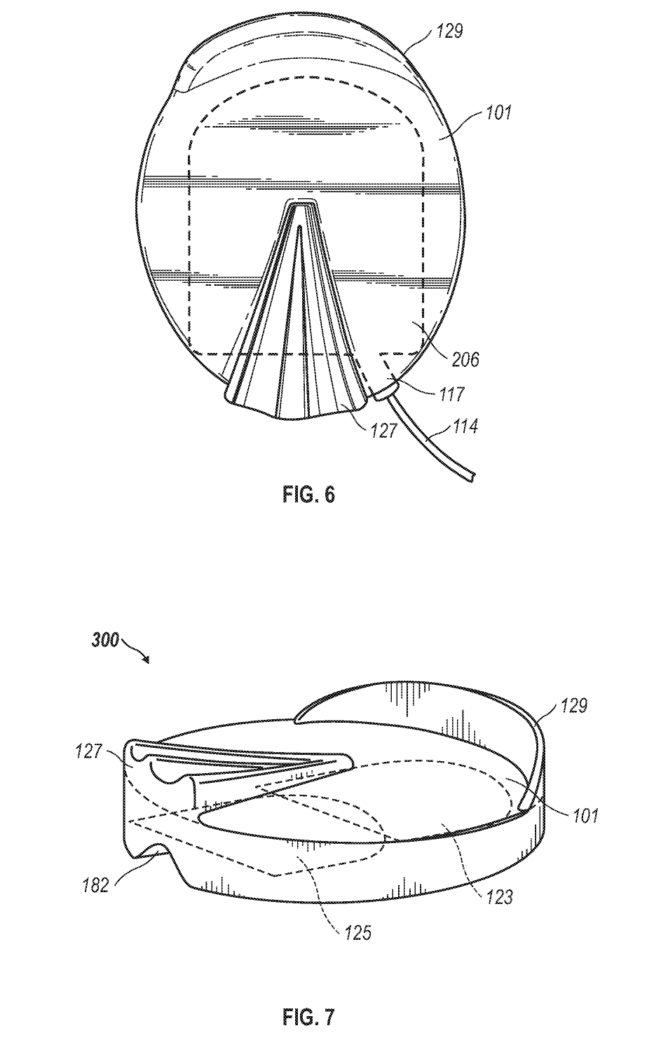

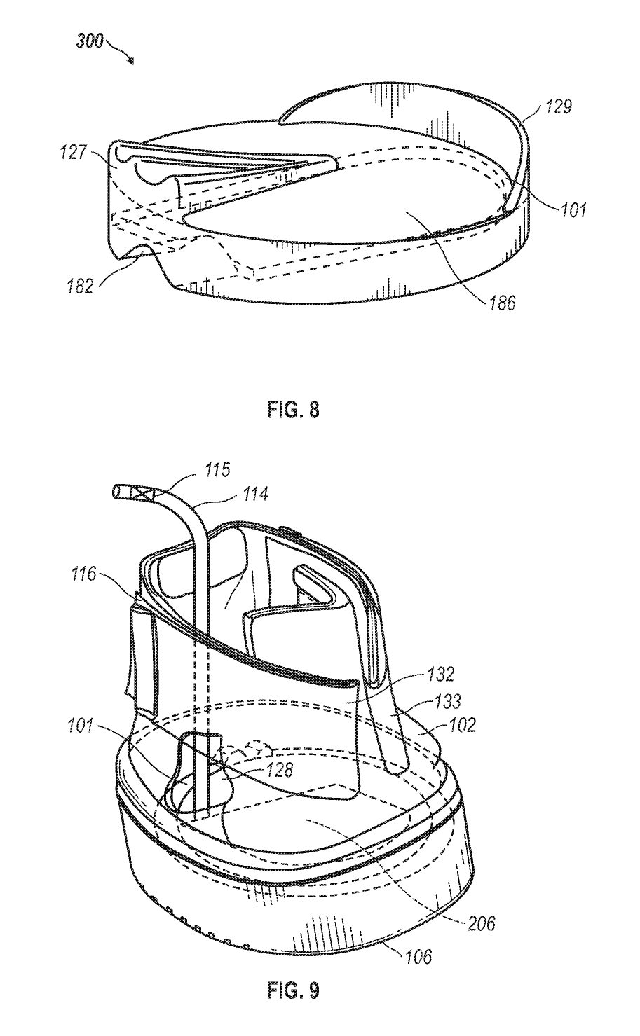

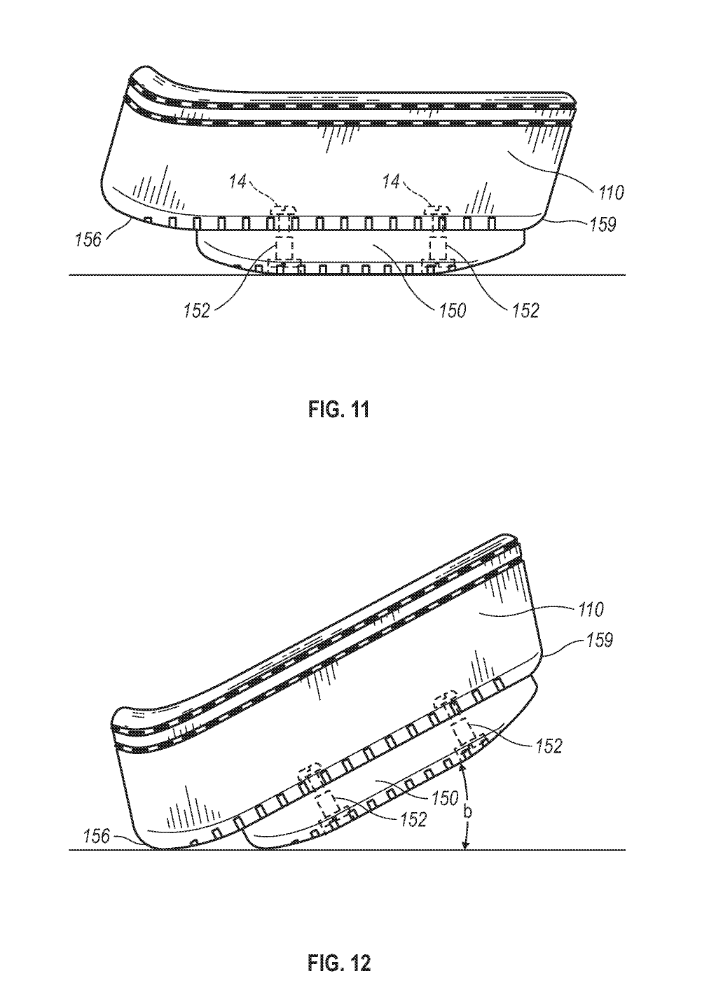

The illustrative orthotic pad shown in FIGS. 4, 6 and 7 is a relatively soft (as more fully described below) elastomeric molded polymer structure. It has a front hoof toe stop 129 and a rear triangular frog support projection 127. The heel lift bladder (wedge), 206, is shown in FIG. 5. The bladder has an outlet conduit connection 117 and conduit 114. A prototype was made on TPU coated fabric that was rf welded together (seam 207 and 209) to form an air tight bag. In some embodiments, as those shown in the Figures, the heel lift is a flexible bladder that may be expanded by injecting fluid or gas into it by conduit 114 through valve 115. The bladder is disposed under the rear bottom surface of an orthotic pad, 101, to raise the heel (rear) section of the pad and thus the equine hoof heel. As shown in FIG. 8 there is optionally provided a shaped depression 182 in the rear of the pad to accommodate the bladder conduit connection 117. This allows the pad to lay flat when it is not inflated. The bladder may be placed in another depression (186 of FIG. 8) in the underside of the pad to allow the pad will lay flatter in the assembly when not inflated. In assembly it is preferred that the conduit connection 117 (and forward extension of a valve) be located in the recess 182 and completely under the bottom surface of the bladder. When the valve is located in the conduit and partially disposed under the orthotic pad the conduit and fill end of the valve will extend through an opening in the rear of the boot sole plate and not in an elongated conduit as is shown in FIGS. 11 and 12. The valve is then accessible from the rear of the boot sole.

The bladder may also be molded into the pad as an integral bag-like space (container) in the pad. The location and size of the molded heel lift means may be varied to provide the most effective action, which will vary with the condition of the hoof and the desired effect. The desired size and location of the heel lift will be influenced by the: 1) placement of the lifting means in relation to the orthotic pad, 2) hardness (or softness) of the pad material above heel lift and 3) depth of gel above and below the heel lift in the orthotic pad. While the invention has been described herein a heel lift system, the bladders may also be placed under the toe section of the hoof or under the sides. By placing a lift under the toe, it is possible to simulate the stretching of the hoof that is used on sound performance equine by first raising the heel to relieve tension on the DDFT then lowering the heel and raising the toe to stretch the SSFT. These techniques will allow a cost effective simulation of stretching. Similarly, bladder placed on the side can be used to change the position of the hoof relative to the legs as is often necessary to straighten crooked legs in colts.

In general, the volume of the bladder will be from about one hundred (100) to about five hundred (500) mL (6.10-30.51 cubic inches); therefore, the amount of fluid required to inflate need not be great, and a pressure system can easily be battery powered and carried by the horse. Required pressure to inflate the bladder is not be excessive—pressures from nearly zero to about two hundred seven (207) kPa (0+ to 30 psi) are effective for inflating the heel lift bladder with pressures from about twenty-one (21) to one hundred thirty-eight (138) kPa (3-20 psi) being preferred. The optimum pressure required for any size and configuration can be easily tested as that needed to raise the heel of the hoof of a standing horse the desired amount, generally about 0.5 to 1.5 inches.

The lift bladder will have at least one inlet port, 117. When air or other gas is the pressurizing fluid used the bladder can be both pressurized and depressurized through a single port by filling and venting, as through a two-way valve or as through a conduit fitted with a pressure relief valve or other pressure relief means. The preferred valve type for the bladder inflation is those valves used in tires—Schrader or American (Presta) valves. Presta valves are suitable and preferred for higher pressures and when the bladder is to remain inflated for longer periods of time. Both these valve types allow the bladder to be easily inflated with air (as from an air pump such as a customary tire pump) and easily deflated. They also aid in making the assembly lightweight and portable without the need for external power sources. As explained above it is desirable that the inlet port 117 and (a valve in some embodiments) located in a recess beneath the orthotic pad and not extend outward from the rear of the pad.

The bladder will preferably have one half of a hook and loop attachment straps (or sheet) affixed to the top and an opposite hook and loop strap (or sheet) half affixed to the bottom side. This will allow the bladder to be secured into the boot assembly (see 125/126 and 121 and 122 of FIGS. 1-3). By using opposite halves on top and bottom the pads may be stacked if desired to use more than one pad or if it is desired to stagger the position of two or more pads. Similar pairs of hook and loop attachments may be used to secure the front of the orthotic pad to the boot bottom as shown as 123/124. The hoof and loop straps (or sheets) are also used to attach the bladder to the bottom of an orthotic pad and the inside bottom surface of a boot.

In some embodiments there is provided a vertical marker placed along the rear section of the equine boot, constructed and placed to indicate the height to which the rear of the orthotic pad is raised when the lift means is activated. This may be a separate strip attached, permanently or releasably to the rear section of the outside of the boot, or it may be printed or scribed directly on the boot surface.

In some embodiments there is an accelerometer assembly placed in the orthotic pad that includes an accelerometer, gyroscope (if needed) and transmittal means. The assembly may be molded into the orthotic pad or placed in a suitable recess of the pad, in which case it may be made removable (for replacement components and/or battery, if a battery is used). The assembly may be configured to determine the angle of the wedge and/or whether it is in motion (as when the equine hoof is lifted). This information may be wirelessly transmitted to a receiver (such as a computer, computer tablet or smart phone) and processed by appropriate software to allow a display of the wedge angle and whether the equine is standing on the booted hoof. This information and data can be electronically saved and processed to evaluate the position of the wedge and the equine interaction with the heel lift assembly. Suitable accelerometers are disclosed in U.S. Pat. No. 7,712,365, issued May 11, 2010, the appropriate disclosure of which is incorporated herein by reference

In one or more embodiments the boot assembly of the invention works with commercially available boot systems and very effectively with equine boots and boot/pad assemblies described in U.S. Pat. No. 7,178,321, issued Feb. 20, 2007, U.S. Pat. No. 7,445,051, issued Nov. 4, 2008, U.S. Pat. No. 8,166,734, issued May 1, 2012, U.S. Pat. No. 8,220,231, issued Jul. 17, 2012, U.S. Pat. No. 8,291,683, issued Nov. 23, 2012, U. S. Pat. No. 8,656,691, issued Feb. 24, 2014, U. S. Pat. No. 9,055,732, issued Jun. 16, 2015, 2014 U.S. Pat. Application No. 2015/0325944, U.S. Pat. Application No. 2015/0119772, U.S. Design patents: D565256, issued Mar. 25, 2008, D62508, issued Mar. 25, 2014, issued Mar. 25, 2008 and D33013, issued Jul. 22, 2014, the disclosures of which are incorporated herein by reference for all purposes. The sloped front and rear of the boot sole described in some of these patents and applications provides a more gentle and beneficial break-over than conventional shoes or boots. In some embodiments the sole of the boot is narrower in the front (as is generally preferred) so that lateral break-over is also enhanced. The present invention allows ready customization and adjustment of the break-over point. U.S. Pat. No. 9,055,732 discloses an ice spa boot assembly that is also suitable for the present invention. The bladder wedge described herein may be placed under the orthotic pad (that may be a ridged pad or a pad with frog support) just as in the boots of the other indicated patents and applications and provides the added benefit of ice spa treatment with the heel lift of the present invention. The disclosure of U.S. Pat. No. 9,055,732 is incorporated herein by reference for all purposes. Some of the features of the present invention and the boot pad assembly of these patent and applications are described below.

Break-over, as the term is used herein, is the last point of the hoof or shoe to come off the ground when the horse is moving. The further forward the break-over is, the greater the levering placed on the foot and potential strain on the entire back portion of the leg.

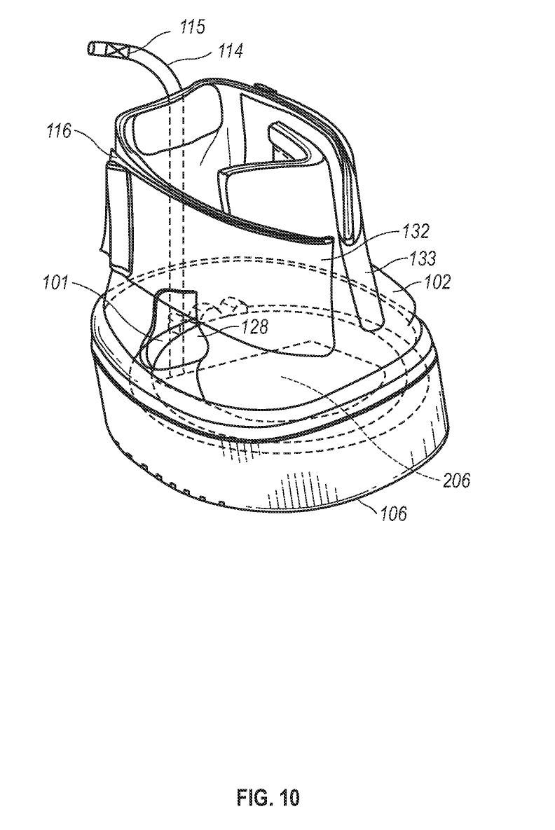

In general, the boots described in the above patents and applications that are suitable for use with heel lift means and optional rocker attachment (described below) comprise an upper portion made from flexible material shaped to fit the hoof of an animal and of a height to reach above the hoof of the animal for which it is designed. As shown in FIGS. 9 and 10 the boot has a front, 102, sides, rear and bottom; the front slopes back and upward, the sides are lower than the front and rear so that when the front and rear are pulled together here is an opening,128, in the sides. There is a fastening means at the top front and rear to fasten the front and rear together around the leg of a horse, (116, 132, 133). The fabric bottom is attached to a more rigid sole plate, 106 comprising a molded elastomer base entirely circumscribed by a peripheral wall (or sides) defining a receiving area sized to fit over (or under) the bottom of the upper portion; said sole plate being securely attached to the lower circumference of the upper portion. As shown in FIGS. 9 and 10 the conduit, 114, from the bladder under the pad 101 may be placed inside the boot rear (FIG. 9) or outside (FIG. 10). If outside there may be a restraining elastomeric band used to surround the boot top (or straps) and conduit to hold it in place.

The sole plate is a preferably a separate molded piece and is attached to the bottom of the fabric boot that encloses the inside bottom of the boot. The sole plate, 106, helps to hold the boot in position on the hoof, and since it is walled around the entire circumference, it prevents the hoof sliding forward or rearward while in use. Moreover, the sole plate complete circumferential surround construction is important in confining an elastomeric orthotic pad in place. If a relatively “soft” pad is used (as is often desirable and sometimes referred to a “deep gel” pad) the weight of the horse will flatten the pad and, if there were an opening in the sole plate side wall the pad would be extruded out the opening. Thus, it is especially important that the bottom circumference of the boot be sufficiently strong to contain the soft pad when it is squeezed outwardly by the pressure of the horses' hoof. By having the sole plate wall entirely surrounding the circumstance the pad is held in place and will conform to the shape of the hoof and adapt to the shape of the hoof as the horse shifts position or moves. This allows the horse to find the best natural balance position—similar to the effect of having the horse stand in loose sand. The ability to achieve natural balance is especially important for horses with injured or diseased hoofs.

In a preferred embodiment the bottom of the sole plate is sloped upward in the front at an angle of about five (5) to thirty (30) degrees from the plane of the bottom. The slope begins at a point on the bottom of the sole plate twenty (20) to forty (40) percent of the length from front to rear of the sole plate. The point of beginning is preferably about ⅓ of the distance from the front of the length of the sole plate. The rear of the sole plate may be similarly sloped or merely rounded. This angled sole plate allows the horse hoof to rock forward and backward without undue pressure on the hoof. When the horse walks the boot will “break-over” in a natural way, preventing abnormal pressure on the hoof. As described above the heel lift of the present invention causes the amount of rounding of the sole to increase as the bladder is inflated, making a dynamic rocker effect. This rocker effect is well recognized as beneficial and there are a number of commercial products, such as the “clog” and other devises designed to “rock” with the shift in body weight of the horse allowing it to achieve a “natural balance”. The front tapered sole plate plus a rocker attachment (described below and FIGS. 11 and 12) provides a kind of double break-over point that provides the horse a “restful” stable platform while eliminating the high load point of its stride, especially important and more pronounced when is turning. The rotating torque during turning is when lameness is most evident and when the most damage to the lamina connective tissue occurs. This can be particularly pronounced in cutting horses. Boots with a narrower front sole width than the rear width also aid in providing better lateral break-over to reduce the effects of rotating torque.

The sole plate is preferably molded of polymeric elastomer material or hard rubber (having the consistency and hardness to approximate automobile tires). Thermoplastic polyurethanes (TPUs) are suitable materials for the base plate. It is preferred that thermoplastic polyurethanes of about 80 to 95 Shore A hardness be used, with Shore A hardness of 90-99 being especially suitable. Harder materials will be brittle and unsuitable and softer material will lack sufficient strength to support the hoof and confine the orthotic pad. Other polymer materials with similar characteristics as thermoplastic polyurethanes are also usable. Choice of these will be well within the ability of those skilled in the polymer art to select.

The elastomeric orthotic pads in the boot assembly are also important. The base of the elastomeric orthotic pad (FIGS. 4, 6 and 7) is generally shaped to approximate the shape of the animal's hoof print. This pad, made of shock absorbing material can be easily trimmed to conform to the hoof of the individual animal on which it will be used. In one embodiment, on the backside of the pad top surface, opposite the ridge, is a frog support. This is a triangular projection (FIGS. 4, 6, 7 and 8) above the surface of the pad. This triangular projection is designed to approximately correspond to the shape and location of the frog of a horse's hoof. It has been found that the height of the frog support from the sole is very important to provide adequate uniform pressure as well as cushioning of the hoof. This frog support provides increased blood flow to the leg of the animal. The function of the triangle projection is to contact the frog during use, to provide a kind of massage to the frog of the hoof. Thus, blood circulation is stimulated and stress on the animal's legs and tendons are relieved. It is well known that the hoof frog acts somewhat as a blood pump. See for example, U.S. Pat. No. 4,981,010 where it is stated “The horny frog (127) is very elastic and acts as a shock absorber and as a second heart to the horse. As the hoof is pressed against the ground, old blood is forced up and out of the foot. When the hoof is lifted off the ground, the elastic frog (58) springs back, letting new blood into the foot.” The frog support aids in this blood circulation. A relative large and soft pad provides more cushioning and flexible movement a nd enables an equine to adjust the position of its hoof to the most comfortable position.

In other embodiments, the orthotic pad will not have the triangular projection or the front projection. When used with an equine that has an abscessed or injured frog it may be desirable to use a pad without the frog support. Also it is possible to eliminate the front projection for some applications.

It has also been found that the shape of the pad is important. Round pads have been found to not perform well in actual use as slightly elliptical pads; they tend to rotate in the boot. An elliptical shaped pad is desirable to maintain consistent fit and to prevent rotation in the pad in use. The pad is shaped to fit the configuration of the equine hoof; many horses have hoofs that, while elliptical are more nearly round. Arabian horses, as well as horses that have elongated “toes” due to injury, disease or otherwise, have narrower hoofs so the elliptical shape is more pronounced.

The orthotic pad is made of any suitable elastomeric polymer material that provides flexibility, shock absorbency, some degree of elasticity, resilience and dimensional stability. Polyvinyl chloride (PVC), polysilicone and similar elastomers are suitable. In a preferred embodiment, the base is constructed of a cast polyurethane elastomer. For example, polyurethane-casting elastomer having a Shore A hardness of from about 10 to about 70 is suitable. It is preferred that the base be of about 20 to 70 Shore A hardness and the support be of about 8 to 50 Shore A hardness. In one embodiment, very soft pads are desirable. These should be thicker than harder pads and will have a Shore 00 hardness of about 5 to 70. Lighter pads, can also be beneficial. Lighter weight pads as disclosed in U.S. Pat. No. 8,656,601, issued Feb. 25, 2014 are very suitable. The same pads are also disclosed in published application 2014/0033661, published Feb. 6, 2014. The disclosures of this patent and published application is incorporated herein by reference for all purposes.

For the pads of this invention it is preferred that the pad material have low rebound resiliency, generally lower that twenty five (25) percent, and more desirably between two (2) and ten (10) percent.

In another important embodiment the base of the pad is made of components of different densities or hardness, herein referred to a duel density pads. These pads have a base, for example, comprising a front component of shock absorbing material of lower hardness than a rear component, the front component comprising the forward 20 to 40 percent of the length from front to rear of the pad and the rear component comprising 20 to 40 percent of the length of the base from front to rear, wherein the two components overlap in the center of the base that is not occupied solely by the front or rear component. Duel density pads and their characteristics are described in U.S. Pat. No. 7,445,051, issued Nov. 4, 2008, the disclosure of which is incorporated herein by reference for all purposes.

In a specific group of embodiments there is a critical combination of features described individually above, comprising an assembly having a heel lift wedge (such as 206) disposed under the rear or heel section of a soft (“deep gel”) orthotic elastomer pad disposed in the bottom of an equine boot and placed so as to be beneath an equine hoof when in use. The orthotic pad has a Shore 00 hardness of between about 5 and about 70, rebound resiliency of less than 25% and the boot sole plate is sufficiently flexible to bend (and become more rounded when attached to a hoof and the bladder inflated) having a Shore A hardness of about 80 to about 95 and wherein the sole plate has side wall of sufficient height to be at least even with the top of a the orthotic pad disposed in the boot and wherein the sole plate is entire on the bottom (no openings) and is walled around the entire circumference of the bottom of the boot. In another embodiment the orthotic pad as described will have a triangular shaped frog support on the top rear surface of the pad. This combination of critical features provides a unique boot assembly that has a dynamic rocker effect, has deep gel pad the will be pressured into the bottom of and the frog of a hoof to provide support and relief from pain. In some embodiment the orthotic pad and sole plate is made of polyurethane.

In another aspect of the invention the boot assembly comprises a rocker attachment to be attached to the bottom of the boot sole. Suitable rocker attachments are described in published application U.S. 2014/0325944 published Nov. 6, 2014, the disclosure of which is incorporated herein by reference. FIGS. 11 and 12, show side views of a molded equine boot sole plate, 110, with a rocker attachment 150. The illustrated sole plate is usually and preferably comprised of a molded relatively hard elastomeric base and has a patterned bottom surface. The sole plate shown has a sloped front to allow it to more easily tip forward (breajover). FIGS. 11 and 12 show the attachment sloped in front, 106, and rear, 159, making a somewhat symmetrical (front to back) “rocker”.

The rocker attachment shown in the Figures has a taper (slope) toward the front and rear of the hoof and may also be tapered from side to side. While not shown in the Figures, the attachment, or projection, can slope from the centerline-side to side-side—to allow the hoof to rotate or tilt from side to side as well as forward. In general, the side to side taper will be, at the center of the sole plate, such that the outside will be from about 90% to 25% of the thickness of the attachment at the center. Tapering to the side can also be beneficial in relieving pressure when the hoof is turning since during turning there is generally the most pressure upon and therefore the most damage to the coffin bone and lamina.

Polyurethanes are particularly suitable material for the rocker as they are easily moldable in open molds or by injection molding. Other polymer materials with similar characteristics as polyurethane, such as polyvinyl chlorides, styrene butadiene styrene polymer, epoxies and the like, are also usable.

The rocker attachment will work well with most available equine boots. The attachment will be adapted to fit the particular sole of the desired boot bottom, but most have elastomeric or rubber soles and adapting the attachment to fit is well within the skill of the art. It is preferred that the boots have a relatively rigid and substantial sole in order to be able to secure the attachment. Fabric or other excessively flexible boot bottoms will be unsuitable. It is also preferred that the sole plate have an upper-ward extending wall surrounding the circumference to provide sufficient rigidity and prevent distortion from the stress placed upon the rocker attachment.

The combination of the lesser “rocker” aspect of the boot sole as described, together with the “rocker” attachment of this invention and the softer deep gel pad gives the maximum flexibility for a horse to shift the weight and pressure points of its stance to find the most comfortable and least damaging position. This combination of a boot/pad/lift/rocker attachment is an important embodiment of this invention.

In another aspect the invention is a kit for providing a boot assembly with heel lift means and optional rocker attachment to the underside of an equine boot comprising The kit will comprise the lift bladder and optionally an orthotic pad and a rocker attachment and securing means for the rocker attached all packaged together for convenience. The user may specify the boot by name or description and lift bladder, orthotic and/or rocker attachment, optionally with instructions, to fit the boot can be supplied. Since there are thousands of boots by type, design and size, many of the components will be custom made to order.

The invention is also a method of using the boot assemblies described herein. In order to effectively position the heel lift of the invention it is desirable to begin with a radiograph of the damaged hoof to determine the position of and need for lifting. Moreover, it will be desirable to use radiographs during treatment (with a heel lift) as it can be beneficial to change the degree of lift periodically. For example, it may be beneficial to have a higher lift during the day (even if it makes the stance more unstable) and a lower lift at night when the equine is a rest and needs a more stable stance. It may even be beneficial to change the degree of lift periodically as the changing of position (and therefore the stance and stability of the equine) may assist in healing and greater comfort for the equine.

Thus, the method of an embodiment of the invention will comprise fitting an equine hoof with a suitable boot with a lift heel lift means disposed beneath an orthotic pad under the equine heel (rear portion of hoof); taking a radiograph of a damaged hoof; determining the most appropriate lift position; and activating the heel mean to the predetermined position. Radiographs may also be repeated after the lift means is activated.

In another method simulating stretching of the hoof components an adjustable bladder disposed beneath the rear an adjustable bladder disposed beneath the front of the orthotic pad and wherein first the bladder under the rear is inflated then deflated and bladder under the front is inflated and deflated and the sequence of rear and front inflation/deflation is repeated a predetermined number of times for predetermined periods of time. Thus, each inflation may be for a period of about 5 to 30 minutes and the number of cycles be 1 to 8. A similar cycle may be used with bladders disposed under the sides of the orthotic pad.

It is also desirable to provide a platform for the hoof for radiographs so that the radiograph will be properly positioned. Such radiograph platforms are well known in the art. See, for example, U.S. application 2013/0129056, published May 23, 2013, the disclosure of which is incorporated herein by reference for al purposes.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded as illustrative rather than a restrictive. Therefore, the scope of the invention should be limited only by the appended claims.

1. An equine boot assembly comprising an equine boot having an inside bottom and having disposed in the inside bottom thereof an elastomer orthotic pad that has a front and rear section and means placed under the elastomeric orthotic pad means to adjustably raise a section of the orthotic pad.

2. The system of claim 1 wherein the means to adjustably raise a section of the orthotic pad is an inflatable bladder.

3. The system of claim 1 the orthotic pad has a top surface, a front and rear, and there is a raised triangular projection on the rear top surface of the pad positioned to contact the frog of an equine hoof when an equine hoof is placed in the boot.

4. The system of claim 3 wherein orthotic pad is an elastomer having a Shore A hardness of from about 20 to 70 and is at least ½ inch in thickness.

5. The system of claim 1 wherein the equine boot has a top, sides and bottom and is constructed of fabric extending around the sides and bottom of the boot structure and wherein he fabric bottom is attached to a more rigid sole plate comprising a molded elastomer base entirely circumscribed by a peripheral wall defining a receiving area sized to fit over the bottom of the boot said sole plate being securely attached to the lower circumference of the upper portion.

6. The system of claim 1 wherein the is provided a vertical marker placed along the rear section of the equine boot, constructed and placed to indicate the height to which the rear of the orthotic pad is raised when the means to adjustably raise the rear section of the pad is activated.

7. The system of claim 2 wherein the bladder is disposed beneath the orthotic pad that has a front, a rear a right side and left side in a location selected from the heel, the right or left side or the front or combination of those locations.

8. The system of claim 1 wherein there is disposed an accelerometer assembly in the orthotic pad configured to indicate the angle of and/or hoof pressure on the pad and wirelessly communicate information to a receiver.

9. The system of claim 1 wherein the elastomeric orthotic pad has a top surface and an underside, a front and rear and has a depression on the underside shaped and sized to accept an inflatable bladder and a larger depressing at the rear underside shaped and sized to accept a conduit fitting of an inflatable bladder.

10. A method of adjusting the angle of a damaged equine hoof relative to the ground surface comprising:
a) taking a radiograph image of a damaged equine hoof from the side;
b) determining an appropriate angle from the plane of the ground surface that will relieve pressure on the damaged area of the hoof;
c) disposing the hoof in a boot having an elastomer pad having a front and rear section disposed in the bottom thereof under which is placed means to adjustably raise the rear section of the pad;
d) activating the means to adjustably raise the rear section the pad to a level predetermined in b).

11. The method of claim 10 wherein the hoof condition is monitored by periodic radiographs and the height of lift adjusted in response.

12. The method of claim 10 wherein the means to adjustably raise the rear section of the pad is an inflatable bladder.

13. The method of claim 10 the orthotic pad has a top surface and there is a raised projection on the top surface of the rear of the pad positioned to contact the frog of an equine hoof when an equine hoof is placed in the boot.

14. The method of claim 14 wherein orthotic pad is an elastomer having a Shore A hardness of from about 20 to 70 and is at least ½ inch in thickness.

15. The method of claim 10 wherein the equine boot has a top, sides and bottom and is constructed of fabric extending around the sides and bottom of the boot structure and wherein he fabric bottom is attached to a more rigid sole plate comprising a molded elastomer base entirely circumscribed by a peripheral wall defining a receiving area sized to fit over the bottom of the boot said sole plate being securely attached to the lower circumference of the upper portion.

16. The method of claim 10 wherein there is an adjustable bladder disposed beneath the rear an adjustable bladder disposed beneath the front of the orthotic pad and wherein first the bladder under the rear is inflated then deflated and bladder under the front is inflated and deflated and the sequence of rear and front inflation/deflation is repeated a predetermined number of times for predetermined periods of time.

17. The method of claim 10 wherein there is disposed an accelerometer assembly in the orthotic pad configured to indicate the angle of and/or hoof pressure on the pad and wirelessly communicate information to a receiver.

18. A kit comprising an elastomeric orthotic pad adapted for disposing in an equine boot and a heel lift inflatable bladder adapted to be disposed beneath the orthotic pad.

19. The kit of claim 18 wherein the elastomeric orthotic pad has a top surface and an underside, a front and rear and has a depression on the underside shaped and sized to accept an inflatable bladder and a larger depression at the rear underside shaped and sized to accept a conduit fitting of an inflatable bladder.

20. The kit of claim 18 also comprising a rocker attachment adapted to be used on bottom underside of the equine boot.
